(19) United States
(12) Patent Application Publication
(10) Pub. No.: US 2009/0272712 A1
(43) Pub. Date: Nov. 5, 2009

(54) PLASTIC DRINKS BOTTLE WITH CAP

(76) Inventor: Rolf MUHLEMANN, Schlattingen (CH)

Correspondence Address: PAULEY PETERSEN & ERICKSON, 2800 WEST HIGGINS ROAD, SUITE 365, HOFFMAN ESTATES, IL, 60169, US

(21) Appl. No.: 12/430,669

(22) Filed: Apr. 27, 2009

Related U.S. Application Data
(63) Continuation of application No. 10/566,528, filed on Jan. 30, 2006.

(30) Foreign Application Priority Data
Jul. 30, 2003 (CH) 1332/03

(51) Int. Cl. B65B 7/28; B23P 11/00

(52) U.S. Cl. 215/43; 29/428

(57) ABSTRACT

A cap, with contents in a container for delivery, retained in a sealed manner and sealed against a container neck, whereby the cap is welded to a container neck in the manner of a membrane. The cap has dimensions so that it can be tightly retained with a conical section thereof in the container neck or in a conical housing volume of a welding head, with an accurate fit. An edge of the cap is welded to a container front wall.

### CROSS REFERENCE TO RELATED APPLICATION(S)

This application is a continuation of U.S. application Ser. No. 10/566,528, filed on 30 Jan. 2006. The co-pending parent application is hereby incorporated by reference herein in its entirety and is made a part hereof, including but not limited to those portions which specifically appear hereinafter.

### BACKGROUND OF THE INVENTION

1. Field of the Invention

This invention relates to a plastics drinks bottle with a neck and with a closure attached thereon and with an aluminum capsule with an active ingredient in solid, powder or liquid form which is enclosed in the capsule and which is to be dispensed into the bottle contents.

2. Discussion of Related Art

Aluminum capsules in which active ingredients are kept in a manner capable of being stored before they are added to the base substance, are known. One of the known examples is coffee in capsules, through which freshly boiled water is poured.

Drinks with a high vitamin content may only be stored in a very limited manner, because the vitamins break down under the influence of heat or light. Accordingly, such drinks need to be stored and transported in a cooled manner, which leads to a higher sales price. Also, a filling in non-transparent or opaque bottles likewise leads to higher costs and reduces their aesthetic appearance. To compensate for this, a completely printed covering is required.

A solution is known from PCT International Application WO 00/27717. Here, a capsule with a raised part to the top is placed onto the bottle neck and with a closure is held thereon in a clamped manner. The closure is designed so that the capsule is destroyed by way of pressure on its flexible cover surface, and the content may be dispensed into the container.

A similarly designed solution is taught by PCT International Application WO 98/40289. However, here the capsule is accommodated in the closure and the closure has a mechanism which permits the capsule to be pierced open. Logically, this demands the capsules to be filled in the closure and held therein, before they are supplied to a filling station. This may hardly be accomplished in practice for hygienic and logistical reasons.

According to PCT International Application WO 98/40289, the closure is removed after emptying the capsule and the capsule is to be removed. According to PCT International Application WO 01/36289, the container with a closure which comprises a piercing means is displaceable in a spout and thus can act simultaneously as a piercing means and a valve.

Finally, a closure with a capsule known from Great Britain Patent Reference GB-A-2,364,699 is held in the closure and on the container neck in a sealed manner amid the intermediate inlay of a viewing disk.

Very high speeds are vital in all filling works known today. As a result, it is inconceivable for a capsule to be placed onto the bottle neck after filling, and for a closure to be screwed on after this step. During this time period the transport on a transport path also takes place, and thus the loosely applied capsules can fall off before a closure is pushed thereover and screwed on. A post-foaming occurs with many drinks on filling, which may likewise lead to the capsule falling from the bottle neck.

The manufacture of capsules is effected with a very high dimensional accuracy. This is also the case with the design of the necks of the bottles but is more problematic with regard to closures. Accordingly, the assembly of capsules in closures is problematic and necessitates additional sealing measures, for example the inlay of soft rubber seals and the like. This causes an increased material expense and an additional assembly step, with corresponding higher costs.

### SUMMARY OF THE INVENTION

For a successful introduction into the market, the previously mentioned problems should be resolved. Accordingly, it is one object of this invention to provide a bottle and an aluminum capsule so that amid the application of a method according to this invention, one may implement a filling in current filling installations without losses in quality or quantity.

These and other objects are achieved by the plastics drinks bottle defined in this specification and in the claims.

The direct welding of the capsules onto the container neck provides several additional advantages. Sealing problems which occur otherwise are solved by way of the welding. The welding which is otherwise only usual with products which are at risk of oxidation, such as ketchup and oily substances, here leads to an improved sealing, which not only increases the storage capability of the product, but also renders superfluous the sealing between the capsule and closure, as well as between the capsule and bottle, which is otherwise required.

There can be an exact fitting design of the capsule may be attached to the bottle neck, so that a spilling due to subsequently foaming drinks may not occur.

The fitting accuracy may also be used for a clamped mounting in the receiver of the welding head, by which an intimate connection to the welding stamp is ensured. After the welding is effected, the capsule is pulled from the mounting. If the welding is inadequate, then the capsule remains in the mounting and the unwelded bottle is sorted out.

### BRIEF DESCRIPTION OF THE DRAWINGS

Two embodiments of this invention are represented in the accompanying drawings, and are explained by way of the subsequent description, wherein:

FIGS. 1A-D show a bottle neck and a capsule in four different assembly steps, wherein the raised part of the capsule projects upwards from the bottle neck;

FIGS. 2A-D show a bottle neck and a capsule in four assembly steps, wherein the capsule with its raised part projects upwards from the bottle neck;

FIGS. 3A and 3B each shows the capsule alone in an enlarged scale, in a partly sectioned lateral view and in a plan view of the raised surface; and

FIG. 4 shows an alternative form of a capsule taken in a diagonal section.

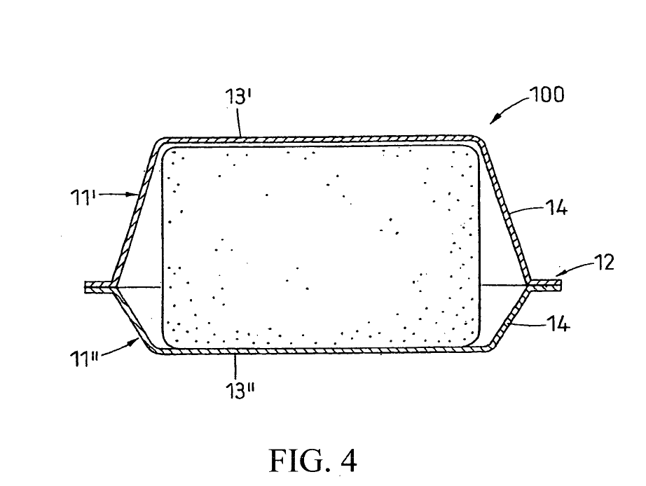

### DETAILED DESCRIPTION OF THE INVENTION

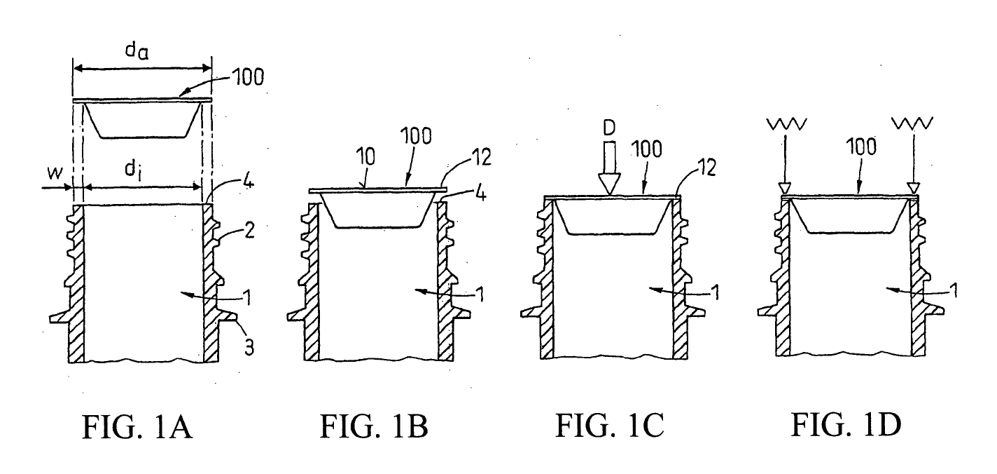

A bottle neck is indicated at 1 in FIGS. 1A-D and 2A-D. More generally, this is called a container neck 1. The entirety of the container or bottle is not shown, because the bottle or container body is not essential to this invention and may be designed in any manner.

The design of the closure is also not relevant and is accordingly not shown here. With regard to the closure, it may be the case of a screw closure or of a hinge closure, and the connection between the bottle or container neck 1 and the closure may practically include all known forms of connection, such as a thread, knock-on bead or spike closure. In principle, the cross section of the container neck 1 may have any shape, particularly if not using a threaded connection.

Preferably, there is an exact adaptation of the capsule to the container neck with regard to the shape. Because in any case one desires as little as possible variants on manufacture of the capsule, one would preferably stick to the usual few standards of drinks bottles, wherein here the known wide-neck bottles with a container neck diameter over 20 mm are preferred. Such a standard bottle neck is represented in the Figures, with an outer thread 2 and a lower retaining collar 3 which on manufacture of the preform of the bottle, is required for mounting in the blowing machine. The bottle necks which are manufactured in injection molds, are extremely accurate with regard to shape, and do not change during the blowing procedure. The dimensions of such a bottle neck are thus within very tight tolerances.

The variables of interest here are the outer diameter of the bottle neck dₐ, the inner diameter of the bottle neck di and the bottle neck wall thickness w, which results as 1/2(dₐ−di).

The end-face 4 of the bottle neck must also be formed in an exact manner. Here the evenness of the bottle neck end-face 4 is important. Any unevenness leads to a worsening of the welding, which is yet to be described.

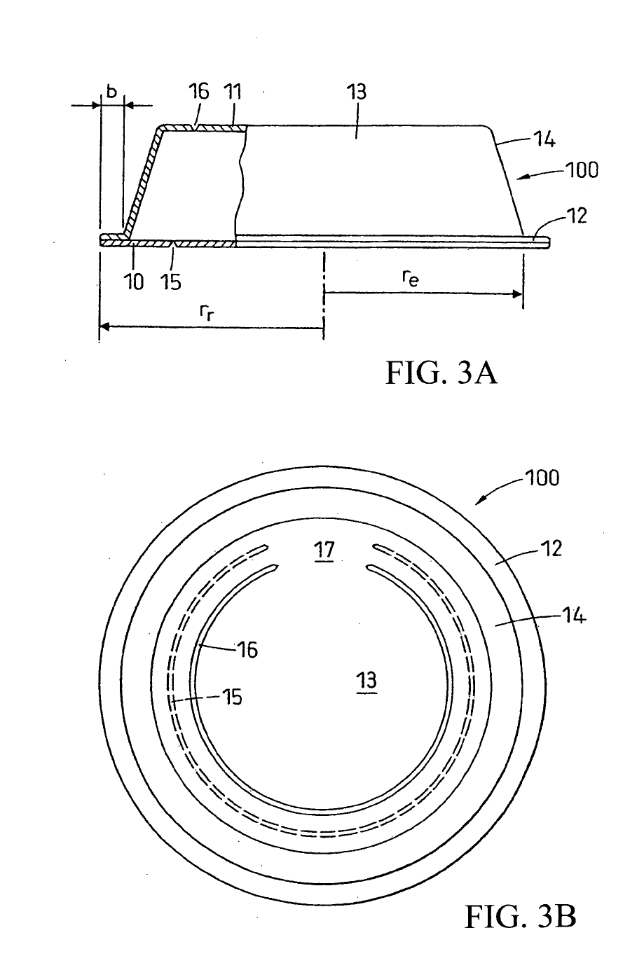

FIGS. 3A and B show the design of the capsule. The capsule itself is indicated in its entirety at 100 and comprises two films, wherein the one film forms a plane surface 10 and the other film forms a surface with a central raised part 11. The two surfaces 10 and 11 are connected to one another in the region of the peripheral edge 12. The two films 10, 11 are welded or bonded in the region of the edges 12. Films 10 and 11 can be coated aluminum films, wherein the welding actually represents a weld connection of the coatings, which is possible at significantly lower temperatures than an aluminum to aluminum welding.

The outer diameter of the capsule corresponds to the diameter of the edge and is 2 rᵣ. The diameter of the upper parallel surface, the so-called central, raised part 13, just as the height of the raised part 13, plays less of a role. A conically inclined wall 14 runs down from the raised part to the edge 12. The inclination should be relatively steep and preferably should run inclined upwards from the horizontal of the edge 12 at an angle of approx. 85° to 600. This inclination simplifies an automatic placing of the capsules onto a container neck, without jamming.

The width b of the edge 12 corresponds relatively accurately to the dimension w of the end-wall surface of the container neck 1. Thus, the inner diameter re of the edge 12 corresponds to the inner diameter di of the container neck. These two dimensions are matched to one another such that the capsule 100 is accommodated in the container neck 1 in an exactly fitting manner. Thus with the placing-on of the capsule 100 with the raised part towards the inner side of the container neck, this falls in under the intrinsic weight in a centering manner, as shown in FIG. 1B. Only under pressure D does the capsule come into the end position, where it is held in the container neck 1 in a clamped manner and the edge 12 of the capsule lies on the container neck end-face 4, as is shown in FIG. 1C. In this position, a post-foaming of a filled drink is prevented and a floating-off of the capsule is not possible. This also permits the receptacle to be transported further from the filling station, and in the remote position for the welding to take place which is symbolically represented in FIG. 1D.

This arrangement does not correspond to the conventional arrangement of capsules on bottles. In particular, if the capsules are designed as blisters, then this arrangement is not used because only the plane surface 10 may be pierced. Accordingly, with the aluminum capsule 100 selected here, it is suggested to provide the surfaces 10 and 11 with breakage lines 15 and 16 respectively, such as shown in FIG. 3. These are thin locations which are pressed in the film on shaping, in the form of channels, which simplify a corresponding breaking-through. The breakage lines 15, 16 are designed as circular lines which are peripheral at least to three quarters, so a bend-up zone 17 which is not weakened, remains.

Because the capsule 100 remains on the container neck 1, it is useful to incorporate circular breakage lines 15 and 16 on the flat side 10 as well as on the side with a central raised part 13. Thus, one would select the diameter of both breakage lines such that the larger diameter lies closer to the container interior.

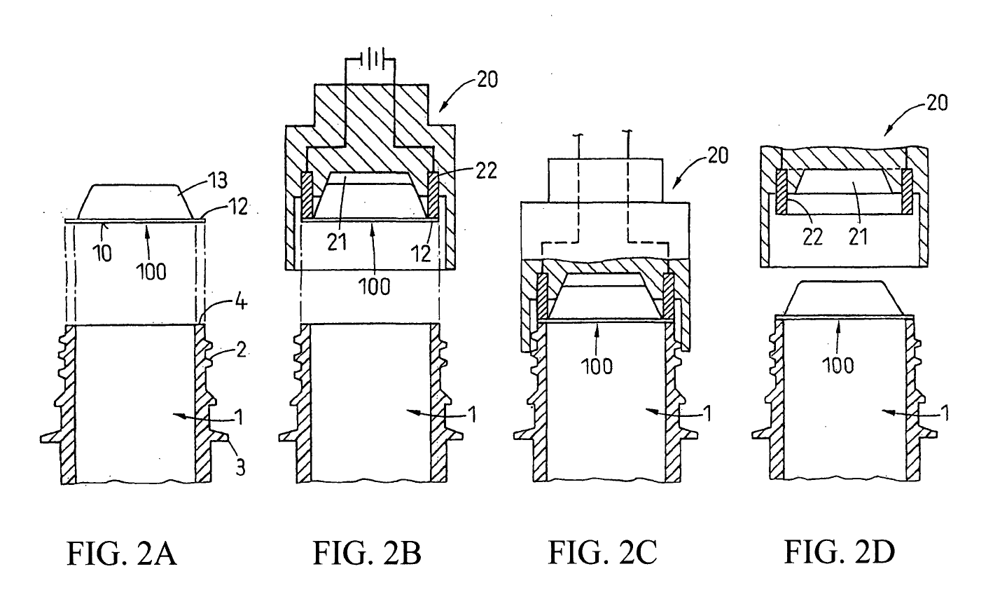

The previously described solution is definitely the most preferred one. Certain conditions, in particular relatively small container diameters may however lead to the fact that the embodiment shown in the FIGS. 2A to 2D must be selected.

With respect to the prior explanations regarding the container neck, with the embodiment according to FIGS. 2A to 2D, the same applies as with the solution according to FIGS. 1A to 1D. The reference numerals are retained. The central, raised part 13 of the capsule projects upwards away from the container neck 1. The method is accordingly different compared to the previously described solution. The fitting accuracy is no longer required between the capsule 100 and the container neck 1, but between a welding head 20 and the capsule 100. The welding head 20 has a receiver space 21 in which the capsule 100 as previously, is accommodated in the container neck 1 in an exactly fitting manner. If the capsule does not hold in the receiver space 21, then it is not dimensionally accurate and falls out of the receiver space 21. This forms an automatic dimensional control. This situation is shown in FIG. 2B.

An electrically heated annular wall 2 as a heating stamp 22 is shown peripherally around the receiver space 21. The heating stamp 22 is preferably mounted in a resilient manner, wherein firstly an electrical contact is formed in the pressed condition. This is effected by pressing the welding head 20 over the container neck, until the collar presses on the container neck end-face 4, and the heating stamp 22 presses on the edge 12 of the capsule and the welding is effected.

On lifting up the welding head 20, the capsule 100 is pulled from the receiver space 21 in which the capsule is held in a clamped manner. Here, a tension is exerted on the weld connection between the bottle neck and the capsule. With a correct welding, the capsule remains on the bottle neck in Figure D while an incorrect welding is not capable of accommodating this force, and the capsule is torn away. This forms a further control.

The first-described solution necessitates a lower effort with regard to a machine apparatus. Despite this, filling installations may exist with which the second embodiment may be realized with a lower effort. The second embodiment is not very suitable for “after-foaming” drinks.

Because the dispensing quantity of the substrate, of the active ingredient or another addition which are to be supplied may be very different, here a solution is also suggested with which the two surfaces 10′ and 11′ both have a suitable raised part 13′ and 13″ respectively. In principle, the two raised parts 13′ and 13″ may be equally high. However it is more preferable to design these differently. The remaining space below the closure permits a larger or smaller raised part, depending on the design of the closure which is to be positioned. With the use of these capsules, one would always press and weld the capsule on the bottle neck in a centered manner, as already previously described. Here too, one must observe the previously described dimensioning conditions.

What is claimed is:

1. A plastic drinks bottle with a neck and a closure attached thereon, an aluminum capsule with an active ingredient in solid, powder or liquid form which is enclosed in the capsule and which is to be dispensed into a bottle contents, wherein the aluminum capsule comprises at least one surface with a central raised part, a conically inclined wall and a peripheral edge, the peripheral edge having an inner diameter and an outer diameter, and the capsule is arranged over a container neck and positioned such that the central raised part projects into the container neck, wherein the outer diameter of the peripheral edge of the capsule corresponds to an outer diameter of the container neck, the inner diameter of the peripheral edge of the capsule corresponds to an inner diameter of the container neck in an exactly fitting manner, and a surface of the peripheral edge adjacent to the central raised part of the capsule is connected to an end-face of the container neck with a weld.

2. A plastic drinks bottle according to claim 1, wherein the capsule at a surface located to an inner side of the bottle in a welded-on condition has a breakage line which represents a circular line weakened over at least three quarters of the circular line, and an unweakened bend-up zone of the circular line remains.

3. A plastic drinks bottle according to claim 1, wherein the capsule on one side comprises a plane surface, and is welded so that a plane surface of the capsule lies away from the container neck.

4. A plastic drinks bottle according to claim 1, wherein the capsule on both sides comprises a raised part with respect to a plane in which the peripheral edge of the capsule runs.

5. A plastic drinks bottle according to claim 4, wherein the two raised parts are raised at a different height from a plane in which the peripheral edge of the capsule extends.

6. A method for closing the plastic drinks bottle with the capsule according to claim 1 comprising, placing the capsule on to the filled bottle with the at least one raised part directed towards an inside of the container neck, the capsule centering itself automatically onto the container neck under the influence of gravity, and then welding the capsule on with one of an annular weld stamp and an ultrasonic welding head.

7. A method of closing the plastic drinks bottle according to claim 6, wherein the centered capsule is pressed into the container neck in a clamping manner until the peripheral edge of the capsule lies on the container neck before the welding.

8. A method of closing the plastic drinks bottle according to claim 3, wherein the capsule, by way of a welding head, is placed onto the container neck with the plane surface, wherein the welding head is placed over the container neck, and the welding head has a conical receiver in which the capsule is aligned centrically to the container neck and then the welding takes place amid an increase of a pressing force.

9. A method of closing the plastic drinks bottle according to claim 6, wherein the aluminum capsule is held in the welding head in a clamped manner with a snug fit, and the capsule is pulled from the conical receiver after the welding, and simultaneously a control of the welding is effected.

10. A plastic drinks bottle and a closure comprising:
a capsule comprising a first surface and a second surface, the first surface joined to the second surface to form a peripheral edge, the peripheral edge including an inner diameter and an outer diameter, and the first surface comprises a central raised part and a conically inclined side wall, the conically inclined side wall extending from the central raised part to the inner diameter of the peripheral edge;
an ingredient in solid, powder or liquid form enclosed in the capsule and which is to be dispensed into a content of the bottle;
the bottle comprising a neck, the neck including an end-face, an inner neck diameter and an outer neck diameter; and
wherein the capsule is positioned over the bottle with the central raised part projecting into the neck of the bottle, the outer diameter of the peripheral edge of the capsule correspondingly aligns with the outer neck diameter of the bottle and the inner diameter of the peripheral edge of the capsule correspondingly aligns with the inner neck diameter of the bottle in an exactly fitting manner, and the peripheral edge of the capsule is welded to the end-face of the neck.

11. The plastic drinks bottle and the closure according to claim 10, wherein the conically inclined side wall allows the capsule to center itself onto the neck during positioning and then the peripheral edge is welded onto the neck with one of an annular weld stamp and an ultrasonic welding head.

12. The plastic drinks bottle and the closure according to claim 11, wherein a diameter of the conically inclined side wall near the peripheral edge of the capsule corresponds to the inner neck diameter such that the capsule must be pressed into the neck until the peripheral edge of the capsule lies on the end-face of the neck before the peripheral edge is welded to the end-face.

13. A method for sealing the plastic drinks bottle and the closure of claim 10, comprising:
placing the capsule onto the neck with the central raised part of the first surface projecting into the neck, wherein a diameter of the conically inclined side wall near the peripheral edge corresponds to the inner diameter of the neck such that the peripheral edge of the capsule does not contact the end-face of the neck;
pressing the capsule towards the bottle until the peripheral edge of the capsule is in contact with the end-face of the neck; and
welding the peripheral edge of the capsule to the end-face of the neck with a welding head.

14. The plastic drinks bottle and the closure according to claim 10, wherein the first surface of the capsule comprises a breakage line which represents a circular line weakened over at least three quarters of a circumference of the circular line and an unweakened zone.

15. The plastic drinks bottle and the closure according to claim 10, wherein the second surface of the capsule comprises a breakage line which represents a circular line weakened over at least three quarters of a circumference of the circular line and an unweakened zone.

16. The plastic drinks bottle and the closure according to claim 10, wherein the second surface of the capsule is a plane surface, and the capsule is welded so that the plane surface of the capsule lies away from the neck.

17. The plastic drinks bottle and the closure according to claim 10, wherein the second surface of the capsule comprises a raised part.

18. The plastic drinks bottle and the closure according to claim 17, wherein the central raised part of the first surface and the raised part of the second surface are raised at different heights from the peripheral edge of the capsule.
